(19) United States
(12) Patent Application Publication
(10) Pub. No.: US 2024/0260547 A1
(43) Pub. Date: Aug. 8, 2024

(54) APPARATUS FOR MONITORING VECTORS OF LIVESTOCK DISEASES, SYSTEM HAVING THE SAME AND METHOD OF MONITORING VECTORS OF LIVESTOCK DISEASES

(71) Applicant: ELECTRONICS AND TELECOMMUNICATIONS RESEARCH INSTITUTE, Daejeon (KR)

(72) Inventors: Jae Young JUNG, Daejeon (KR); Se Han KIM, Daejeon (KR); Bong Kuk LEE, Daejeon (KR)

(21) Appl. No.: 18/413,218

(22) Filed: Jan. 16, 2024

(30) Foreign Application Priority Data
Feb. 3, 2023 (KR) 10-2023-0014996

(51) Int. Cl. A01K 29/00; G06V 10/20; G06V 10/82; G06V 20/52; G06V 20/62; G06V 20/64; G06V 40/10; G06V 40/20; H04N 23/23

(52) U.S. Cl. CPC A01K 29/005; G06V 10/20; G06V 10/82; G06V 20/52; G06V 20/625; G06V 20/64; G06V 40/10; G06V 40/20; H04N 23/23; G06V 2201/08; G06V 2201/10

(57) ABSTRACT

The present invention relates to an apparatus for monitoring vectors of livestock diseases, a system having the same, and a method of monitoring vectors of livestock diseases, and the apparatus for monitoring vectors of livestock diseases includes a communication module, at least one sensor module, and a processor configured to recognize at least one of information on a vehicle entering or exiting a corresponding region, information on a person exiting a vehicle, and information on a wild animal on the basis of sensing data collected through the at least one sensor module and transmit the recognized information and device status information to an external device through the communication module.

### CROSS-REFERENCE TO RELATED APPLICATION

This application claims priority to and the benefit of Korean Patent Application No. 10-2023-0014996, filed on Feb. 3, 2023, the disclosure of which is incorporated herein by reference in its entirety.

### BACKGROUND

### 1. Field of the Invention

The present invention relates to an apparatus for monitoring vectors of livestock diseases, a system having the same, and a method of monitoring vectors of livestock diseases.

### 2. Description of Related Art

Recently, livestock diseases causing enormous damage such as malignant livestock infectious diseases, such as African swine fever, foot-and-mouth disease, avian influenza, and the like, are frequently occurring at home and abroad.

According to the results of the domestic livestock disease epidemiological investigation (Veterinary Epidemiology Division of the Animal and Plant Quarantine Agency, 2015), the rate of introduction of vectors of livestock diseases by vehicles was the highest at 78.9%, followed by people (10.8%), nearby transmission (8.6%), and animal movement (1.6%). In the case of avian influenza, as outbreaks of highly pathogenic avian influenza are occurring one after another even in poultry farms far from migratory bird habitats, special surveillance is being carried out on small rivers near poultry farms.

Meanwhile, wildlife disease diagnostic agencies, such as the National Wildlife Disease Control Center and the Animal Sanitation Laboratory in each city and province, are thoroughly preparing by receiving reports of dead bodies suspected of avian influenza at all times and conducting diagnosis. Promotions to discourage people from visiting migratory bird habitats are underway, but when visits are unavoidable, quarantine management is required by wearing quarantine items such as quarantine suits, quarantine boots, quarantine gloves, and the like.

Conventionally, in order to manage migratory bird habitats, the public is requested to cooperate in restricting entry to migratory bird habitats, and the reality is that in cooperation with local governments, access to migratory bird habitats is controlled by installing information banners, deploying patrol personnel, and the like. In addition, the habitat distribution and movement status of winter migratory birds, quarantine management of visitors, collection of dead wild birds, and the like are conducted through visual inspection or photography by on-site patrol personnel. In this way, in order to monitor vectors of livestock diseases, patrol personnel are inspecting vectors of livestock diseases with the naked eye or photographs at wild animal appearance sites.

However, in the conventional method of monitoring vectors of livestock diseases, patrol personnel should visit the site, there is a risk that vectors of livestock diseases may be spread to nearby farms due to the patrol personnel's on-site visits, and the human approach has a limitation in 24-hour monitoring.

The related art of the present invention is disclosed in Korean Patent Registration No. 10-1699864 (published on Feb. 3, 2017).

### SUMMARY OF THE INVENTION

The present invention is directed to providing an apparatus for monitoring vectors of livestock diseases that can remotely monitor vectors of livestock diseases in a region without electricity and the Internet, a system having the same, and a method of monitoring vectors of livestock diseases.

According to an aspect of the present disclosure, there is provided an apparatus for monitoring vectors of livestock diseases, which includes a communication module, at least one sensor module, and a processor configured to recognize at least one of information on a vehicle entering or exiting a corresponding region, information on a person exiting a vehicle, and information on a wild animal on the basis of sensing data collected through the at least one sensor module and transmit the recognized information and device status information to an external device through the communication module.

The sensor module may include a first image sensor module configured to acquire a thermal image, a second image sensor module configured to acquire a real image, and a distance measurement sensor module configured to measure a distance to an object.

The processor may include an image correction unit configured to correct the thermal image acquired through the first image sensor module and the real image acquired through the second image sensor module to match each other, an object detection unit configured to detect at least one object among a vehicle, a person, and a wild animal corresponding to a preset class in the corrected real image, an object information recognition and processing unit configured to, when a vehicle is detected by the object detection unit, recognize vehicle information including a type and license number of the detected vehicle, when a person is detected by the object detection unit, recognize information on the person exiting the vehicle, including whether the detected person is exiting the vehicle or whether he or she is wearing a quarantine suit, and when a wild animal is detected by the object detection unit, recognize wild animal information including whether the detected wild animal is a dead body and a recognition distance to the dead body, and a metadata generation unit configured to generate at least one of the information on the vehicle, the information on the person exiting the vehicle, and the information on the wild animal that are recognized by the object information recognition and processing unit, and device status information of the apparatus for monitoring vectors of livestock diseases as metadata.

The processor may further include a preprocessing unit configured to perform at least one operation among adjusting a number of frames per second, converting a size of the frame, and data augmentation on the real image and thermal image corrected by the image correction unit.

The image correction unit may adjust intrinsic parameters of the first image sensor module and the second image sensor module to perform image matching in which locations of objects match in the thermal image and the real image.

The object information recognition and processing unit may determine whether the detected person is a person exiting the vehicle on the basis of at least one of whether there is tracking information on the detected person, whether there is an overlapping vehicle, and a movement speed, and when the detected person is the person exiting the vehicle, the object information recognition and processing unit may crop a person image on the basis of coordinates of the person exiting the vehicle, apply deep learning to the cropped person image to determine whether the person exiting the vehicle is wearing a quarantine suit, and recognize the information on the person exiting the vehicle.

The object information recognition and processing unit may measure a body temperature of the wild animal on the basis of temperature distribution information of the thermal image that matches the real image in which the wild animal is detected, determine whether the wild animal is a dead body on the basis of the measured body temperature, and when it is determined that the wild animal is a dead body, recognize a distance to the dead body measured through the distance measurement sensor module.

The device status information may include power on information on whether momentary power of the apparatus for monitoring vectors of livestock diseases is turned on, and alive information for determining whether the apparatus for monitoring vectors of livestock diseases is operating normally.

According to another aspect of the present disclosure, there is provided a system for managing vectors of livestock diseases, which includes a plurality of apparatuses for monitoring vectors of livestock diseases that are each installed in a wild animal habitat and configured to recognize at least one of information on a vehicle entering or exiting a corresponding region, information on a person exiting a vehicle, and information on a wild animal and transmit metadata including the recognized information and device status information to a management server, and the management server configured to predict at least one of a degree of risk livestock disease transmission and a degree of risk a livestock disease outbreak on the basis of the metadata received from the plurality of apparatuses for monitoring vectors of livestock diseases.

The management server may apply at least one of the information on the vehicle, the information on the person exiting the vehicle, and the information on the wild animal to an infectious disease prediction model to predict the degree of risk livestock disease transmission or the degree of risk a livestock disease outbreak.

The management server may generate notification information including at least one of the information on the vehicle, the information on the person exiting the vehicle, and the information on the wild animal, the device status information, the degree of risk livestock disease transmission, and the degree of risk a livestock disease outbreak and transmit the generated notification information to a preset manager.

According to still another aspect of the present disclosure, there is provided a method of monitoring vectors of livestock diseases, which includes receiving, by a processor, sensing data including at least one of a thermal image, a real image, and distance measurement information from a sensor module, recognizing, by the processor, at least one of information on a vehicle entering or exiting a corresponding region, information on a person exiting a vehicle, and information on a wild animal on the basis of the sensing data, and generating, by the processor, metadata including the recognized information and device status information and transmitting the generated metadata to a management server.

The recognizing of the information may include correcting, by the processor, the thermal image and the real image to match each other, detecting, by the processor, at least one object among a vehicle, a person, and a wild animal corresponding to a preset class in the corrected real image, and when a vehicle is detected, recognizing, by the processor, vehicle information including a type and license number of the detected vehicle, when a person is detected, recognizing information on the person exiting the vehicle, including whether the detected person is exiting the vehicle or whether he or she is wearing a quarantine suit, and when a wild animal is detected by the object detection unit, recognizing wild animal information including whether the detected wild animal is a dead body and a recognition distance to the dead body.

The method may further include, after the correcting of the thermal image and the real image, performing, by the processor, at least one preprocessing operation among adjusting a number of frames per second, converting a size of the frame, and data augmentation on the corrected real image and thermal image.

In the correcting of the thermal image and the real image, the processor may adjust intrinsic parameters of a first image sensor module that acquires the real image and a second image sensor module that acquires the thermal image to perform image matching in which locations of objects match in the thermal image and the real image.

In the recognizing of the information, the processor may determine whether the detected person is a person exiting the vehicle on the basis of at least one of whether there is tracking information on the detected person, whether there is an overlapping vehicle, and a movement speed, and when the detected person is the person exiting the vehicle, the processor may crop a person image on the basis of coordinates of the person exiting the vehicle, apply deep learning to the cropped person image to determine whether the person exiting the vehicle is wearing a quarantine suit, and recognize the information on the person exiting the vehicle.

In the recognizing of the information, the processor may measure a body temperature of the wild animal on the basis of temperature distribution information of the thermal image that matches the real image in which the wild animal is detected, determine whether the wild animal is a dead body on the basis of the measured body temperature, and when it is determined that the wild animal is a dead body, recognize a distance to the dead body measured through a distance measurement sensor module.

The device status information may include power on information on whether momentary power of the apparatus for monitoring vectors of livestock diseases is turned on, and alive information for determining whether the apparatus for monitoring vectors of livestock diseases is operating normally.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system for managing vectors of livestock diseases according to an embodiment of the present invention;

FIG. 2 is a block diagram illustrating a configuration of an apparatus for monitoring vectors of livestock diseases according to an embodiment of the present invention;

FIG. 3 is an exemplary diagram for describing a method of recognizing a vehicle license number according to an embodiment of the present invention;

FIG. 4 is an exemplary diagram for describing a situation in which wild animal information is recognized according to an embodiment of the present invention;

FIG. 5 is a diagram for describing a method of managing vectors of livestock diseases according to an embodiment of the present invention;

FIG. 6 is a flowchart for describing a method of monitoring vectors of livestock diseases according to an embodiment of the present invention; and

FIG. 7 is a flowchart for describing a method of recognizing a person exiting a vehicle according to an embodiment of the present invention.

### DETAILED DESCRIPTION OF EXEMPLARY EMBODIMENTS

Hereinafter, examples of an apparatus for monitoring vectors of livestock diseases, a system having the same, and a method of monitoring vectors of livestock diseases according to embodiments of the present invention will be described. In this process, thicknesses of lines, sizes of components, and the like shown in the accompanying drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

The present invention relates to an apparatus for monitoring vectors of livestock diseases that can manage vectors of diseases such as entering or exiting vehicles, entering or exiting personnel, wild birds (avian influenza), and wild boars (African swine fever) at wild animal appearance sites (wild animal habitats) without electricity or the Internet, a system having the same, and a method of monitoring vectors of livestock diseases. That is, the present invention relates to an apparatus for monitoring vectors of livestock diseases that provides license plates of entering or exiting vehicles, quarantine management of persons exiting vehicles, and current status of vectors of livestock diseases at migratory bird habitats or wild boar appearance environments without electricity or the Internet, a system having the same, and a method of monitoring vectors of livestock diseases.

Further, the present invention relates to an apparatus for monitoring vectors of livestock diseases that can check distribution statuses of wild animals in wild animal habitats of each region, current statuses of dead bodies, and information on quarantine of vehicles/persons visiting the habitats by being connected to a platform for managing vectors of livestock diseases through the Internet, a system having the same, and a method of monitoring vectors of livestock diseases.

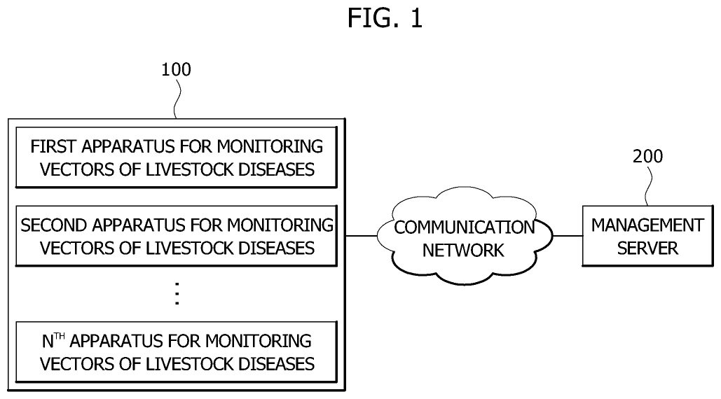

FIG. 1 is a diagram illustrating a system for managing vectors of livestock diseases according to an embodiment of the present invention.

Referring to FIG. 1, the system for managing vectors of livestock diseases according to the embodiment of the present invention includes a plurality of apparatuses 100 for monitoring vectors of livestock diseases and a management server 200.

The plurality of apparatuses 100 for monitoring vectors of livestock diseases may be installed in wild animal habitats in each region, and may recognize at least one of information on a vehicle entering or exiting a corresponding region, information on a person exiting a vehicle, and information on a wild animal and transmit metadata including the recognized information and device status information to the management server 200.

The plurality of apparatuses 100 for monitoring vectors of livestock diseases may be installed in migratory bird habitats or wild boar appearance regions without electricity and the Internet. Therefore, the plurality of apparatuses 100 for monitoring vectors of livestock diseases may monitor vectors of diseases, such as entering or exiting vehicles, entering or exiting personnel, wild birds (avian influenza), wild boars (African swine fever), etc., in an environment without electricity or the Internet.

Each apparatus 100 for monitoring vectors of livestock diseases may be connected to a platform for managing vectors of livestock diseases through the Internet to provide distribution statuses of wild animals in wild animal habitats of each region, a current status of a population, current statuses of dead bodies, and information on quarantine of vehicles/persons visiting the habitats.

When each apparatus 100 for monitoring vectors of livestock diseases stores metadata to be uploaded to the management server 200 in a specific directory folder, the metadata may be automatically transmitted to the management server 200 by an upload folder client program.

The management server 200 may receive the metadata from the plurality of apparatuses 100 for monitoring vectors of livestock diseases and store the received metadata in a database (not illustrated). In this case, the management server 200 receives the metadata through an upload folder server program and stores the received metadata in the database.

The management server 200 may generate notification information on the basis of the metadata received from the plurality of apparatuses 100 for monitoring vectors of livestock diseases and transmit the generated notification information to a preset manager. That is, the management server 200 may generate notification information including vehicle metadata information, vehicle-exiting-person metadata information, wild animal metadata information, device status metadata information, and the like and transmit the generated notification information to a manager. In this case, the management server 200 may transmit the notification information in various forms such as text message, email, and the like.

For example, the management server 200 may notify the manager of wild animal information, including wild animal dead body information, a dead body recognition distance, etc., to allow a quarantine officer to aid in collecting wild animal dead bodies when visiting the site, and to use devices such as drones and unmanned aerial vehicles to collect the dead bodies. Further, the management server 200 may notify the manager of the device status information to allow the manager to check whether each apparatus 100 for monitoring vectors of livestock diseases is operating normally and rapidly replace a broken apparatus 100 for monitoring vectors of livestock diseases.

In this way, the management server 200 may receive metadata including quarantine statuses of entering or exiting vehicles and persons, habitat distribution and movement statuses of wild animals, and statuses of dead wild animals, etc. at migratory bird habitats or wild boar appearance sites from the apparatus 100 for monitoring vectors of livestock diseases installed in the corresponding region to automatically monitor vectors of livestock diseases from a remote place.

Further, a platform for managing vectors of livestock diseases may be installed in the management server 200, and the platform for managing vectors of livestock diseases may predict the degree of risk a livestock disease outbreak, the degree of risk livestock disease transmission, or the like through a prediction model and provide an alarm service on the basis of results of the prediction.

That is, the management server 200 may predict the degree of risk a livestock disease outbreak or the degree of risk livestock disease transmission in each region on the basis of the metadata received from the plurality of apparatuses 100 for monitoring vectors of livestock diseases. In this case, the management server 200 may apply at least one of the vehicle metadata information, the vehicle-exiting-person metadata information, and the wild animal metadata information to an infectious disease prediction model to predict the degree of risk a livestock disease outbreak or the degree of risk livestock disease transmission. The management server 200 may notify the manager of the degree of risk a livestock disease outbreak and the degree of risk livestock disease transmission.

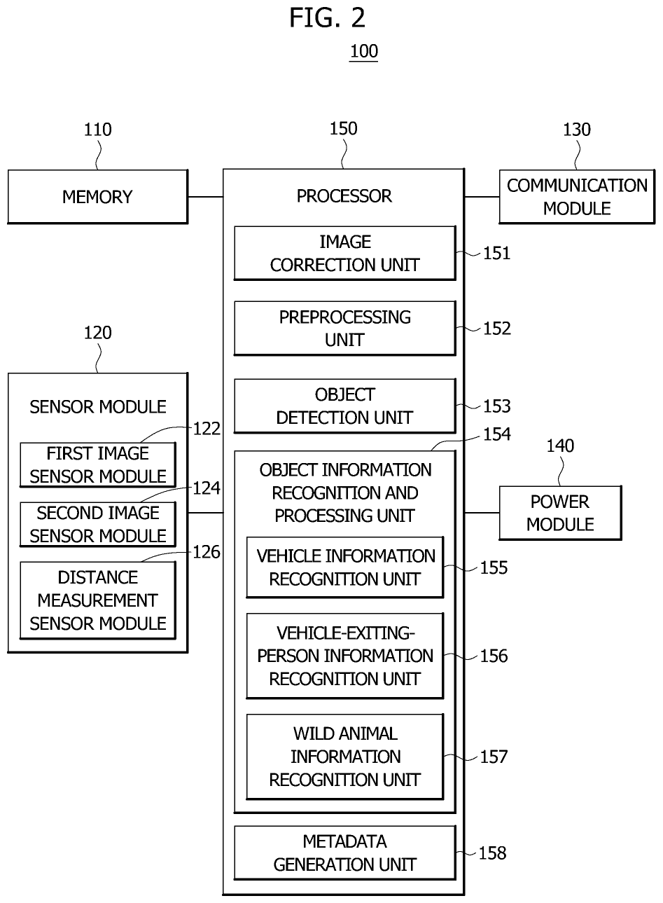

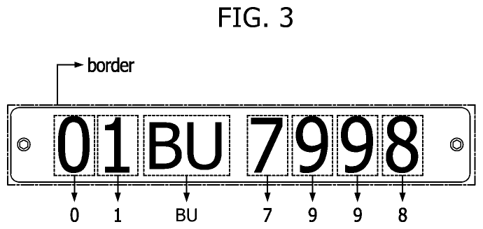

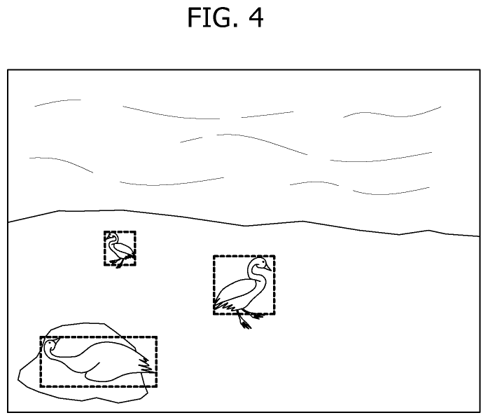

FIG. 2 is a block diagram illustrating a configuration of an apparatus 100 for monitoring vectors of livestock diseases according to an embodiment of the present invention, FIG. 3 is an exemplary diagram for describing a method of recognizing a vehicle license number according to an embodiment of the present invention, and FIG. 4 is an exemplary diagram for describing a situation in which wild animal information is recognized according to an embodiment of the present invention.

Referring to FIG. 2, the apparatus 100 for monitoring vectors of livestock diseases according to the embodiment of the present invention includes a memory 110, a sensor module 120, a communication module 130, a power module 140, and a processor 150.

The memory 110 is a component for storing data related to the operation of the apparatus 100 for monitoring vectors of livestock diseases. In particular, a program (application or applet) and the like that recognizes at least one of information on a vehicle entering or exiting a corresponding region, information on a person exiting a vehicle, and information on a wild animal on the basis of sensing data may be stored in the memory 110, and the stored information may be selected by the processor 150 as necessary. That is, several types of data that are generated during the execution of an operating system or program (application or applet) for driving the apparatus 100 for monitoring vectors of livestock diseases are stored in the memory 110. In this case, a non-volatile storage unit, in which stored information is continuously maintained even without power supply, and a volatile storage unit, in which power is required to maintain the stored information, are generally referred to as the memory 110. Further, the memory 110 may perform a function for temporarily or permanently storing data processed by the processor 150. Here, the memory 110 may include magnetic storage media or flash storage media in addition to volatile storage devices that require power in order to maintain the stored information, but the scope of the present invention is not limited thereto.

The sensor module 120 may acquire sensing data such as a thermal image, a real image, distance measurement information, or the like to transmit the acquired sensing data to the processor 150.

The sensor module 120 may include a first image sensor module 122, a second image sensor module 124, and a distance measurement sensor module 126.

The first image sensor module 122 may acquire a first image to transmit the acquired first image to the processor 150. Here, the first image may be a thermal image. The first image sensor module 122 may be implemented as, for example, a thermal imaging sensor or the like. The thermal imaging sensor may detect thermal radiation emitted from each of at least one subject, and visualize and output a detected body temperature in various colors through thermal resolution. The thermal image may include a temperature distribution image.

The second image sensor module 124 may acquire a second image to transmit the acquired second image to the processor 150. Here, the second image may be a real image. The second image sensor module 124 may be implemented as, for example, a visible light sensor or the like.

Hereinafter, for convenience of description, the first image will be described as a thermal image, and the second image will be described as a real image.

The distance measurement sensor module 126 may measure a distance to an object to transmit information on the measured distance to the processor 150. The distance to the object measured through the distance measurement sensor module 126 may be used to collect location information of a dead body found at the site. The distance measurement sensor module 126 may be implemented as an ultrasonic sensor, a radar sensor, a LiDAR sensor, etc.

The processor 150 may be configured to control the overall operation of the apparatus 100 for monitoring vectors of livestock diseases. For example, the processor 150 may execute software (e.g., a program) stored in the memory 110 to control at least one of the components (e.g., the memory 110, the sensor module 120, the communication module 130, and the power module 140) connected to the processor 150. The processor 150 may be implemented as application specific integrated circuits (ASICs), digital signal processors (DSPs), programmable logic devices (PLDs), field programmable gate arrays (FPGAs), central processing units (CPUs), microcontrollers, and/or microprocessors, but the scope of the present invention is not limited thereto.

The processor 150 may recognize at least one of information on a vehicle entering or exiting a corresponding region, information on a person exiting a vehicle, and information on a wild animal on the basis of the sensing data collected through the sensor module 120 to transmit the recognized information to an external device through the communication module 130. Here, the sensing data may include a thermal image, a real image, distance measurement information, etc.

The processor 150 may detect at least one object among a vehicle, a person, and a wild animal on the basis of the real image. When a vehicle is present in the detected object, the processor 150 may recognize vehicle information including a type and license number of the vehicle, when a person is present in the detected object, the processor 150 may recognize information on a person exiting the vehicle, and when a wild animal is present in the detected object, the processor 150 may recognize wild animal information including whether a wild animal is a dead body and a distance to the dead body.

The processor 150 may generate metadata, including at least one of the recognized vehicle information, information on the person exiting the vehicle, and wild animal information, and device status information, to transmit the generated metadata to the management server 200 through the communication module 130.

The processor 150 may include an image correction unit 151, a preprocessing unit 152, an object detection unit 153, an object information recognition and processing unit 154, and a metadata generation unit 158.

The image correction unit 151 may correct the thermal image acquired through the first image sensor module 122 and the real image acquired through the second image sensor module 124 to match each other.

Since the first image sensor module 122 and the second image sensor module 124 have different physical characteristics such as sensors, lenses, and the like for each product, a resolution, a field of view (FOV), and a location of a central point of view are different, and thus it is necessary to match the thermal image of the first image sensor module 122 and the real image of the second image sensor module 124 in order to match object locations thereof.

Accordingly, the image correction unit 151 may adjust intrinsic parameters of the first image sensor module 122 and the second image sensor module 124 to perform image matching in which locations of objects match in the thermal image and the real image. Here, the intrinsic parameters may include a resolution, a FOV, a sensor size, a focal length, a distortion rate, etc.

That is, the image correction unit 151 may perform image matching using intrinsic parameters that are used to express the coordinate systems of the first image sensor module 122 and the second image sensor module 124. In this case, the image correction unit 151 may use a “calibrateCamera” function in open source computer vision (openCV) that provides the corner coordinates of a chessboard image in order to extract the intrinsic parameter of each of the first image sensor module 122 and the second image sensor module 124. Therefore, the image correction unit 151 may adjust the intrinsic parameters, such as an FOV, a resolution, and the like, of the first image sensor module 122 and the second image sensor module 124 through the “calibrateCamera” function to match the thermal image and the real image. The object location of the thermal image and the object location of the real image may be matched through image matching.

The preprocessing unit 152 may perform preprocessing on the real image corrected by the image correction unit 151. The preprocessing unit 152 may provide a function for adjusting the number of frames per second (fps) of an input video according to a change in features (presence or absence of movement) of frames in a real image that are collected in real time, a function for converting the size of the input frame for object recognition, a data augmentation function for supplementing insufficient learning data, etc. In order to increase the accuracy of an object detection algorithm, various types of learning data are required, and data augmentation may be a widely used technique in object detection algorithms. Table 1 below shows augmentation techniques used to train a video analysis artificial intelligence (AI) module.

TABLE 1

| Vehicle object detection | | Vehicle license plate recognition | |
|---|---|---|---|
| Command | Conversion effect | Command | Conversion effect |
| Fliplr | Left/right | Affine | Affine Transformation |
| | inversion | | |
| Scale | Size conversion | Scale | Size conversion |
| CropAndPad | Crop and margin | Invert | Color inversion |
| | adjustment | | |
| GaussianNoise | Gaussian noise | Grayscale | Grayscale conversion |
| HueAndSaturation | Hue and | Motionblur | Motion blur effect |
| | saturation | | |
| | adjustment | | |
| | | GaussianBlur | Blur effect |
| | | GaussianNoise | Gaussian noise |
| | | HueAndSaturation | Hue and saturation |
| | | | adjustment |
| | | ElasticTransformation | Bending effect |

The object detection unit 153 may detect an object (e.g., a vehicle, a person, a wild animal, etc.) corresponding to a preset class in the corrected or preprocessed real image. In this case, the object detection unit 153 may apply an object detection algorithm to the corrected or preprocessed real image to detect a vehicle, a person, a wild animal, etc.

Further, the object detection unit 153 may generate a bounding box of the detected object.

The object detection unit 153 may learn classes for vehicles, license plates, persons, etc. on the basis of the generated learning data. Further, the object detection unit 153 may learn a class for wild animals, such as wild birds, which are vectors for avian influenza, and wild boars, which are vectors for African swine fever.

The object information recognition and processing unit 154 may recognize vehicle information, including a type and license number of the detected vehicle, when a vehicle is detected by the object detection unit 153, recognize information on a person exiting a vehicle, including whether the detected person has exited the vehicle or whether he or she is wearing a quarantine suit, when a person is detected by the object detection unit 153, and recognize wild animal information, including whether the detected wild animal is a dead body and a recognition distance to the dead body, when a wild animal is detected by the object detection unit 153.

The object information recognition and processing unit 154 may include a vehicle information recognition unit 155, a vehicle-exiting-person information recognition unit 156, and a wild animal information recognition unit 157.

The vehicle information recognition unit 155 may receive an image and bounding box of the vehicle and license plate portion from the object detection unit 153 and recognize vehicle information including a type and license number of the vehicle.

The vehicle information recognition unit 155 may recognize the vehicle type by inputting a vehicle image into a deep learning model. Here, the vehicle type may include a passenger car, a truck, a van, a special car, etc.

Further, the vehicle information recognition unit 155 may recognize the vehicle license number by applying deep learning only to the license plate of the detected vehicle. Specifically, the vehicle information recognition unit 155 may receive an image of the license plate portion and bounding box (BBox) information on the license plate from the object detection unit 153. The vehicle information recognition unit 155 may preferentially check the input license plate from among several vehicles appearing in the same frame, through the bounding box (BBox) information of the license plate. Then, the vehicle information recognition unit 155 may recognize the license number by inputting a license plate image into a deep learning model.

For example, domestic license plates are composed of a total of 90 classes for vehicle license number recognition using deep learning, and the types of classes are composed of {a border, numbers (“0”-“9”), letters (“ga”-“ho”), region names (“Seoul”-“Busan”)}. For example, learning data of a license plate recognition model may be as shown in Table 3 below.

The vehicle-exiting-person information recognition unit 156 may determine whether the person detected by the object detection unit 153 is a person who has exited the vehicle, and when it is determined that the person detected by the object detection unit 153 is a person who has exited the vehicle, the vehicle-exiting-person information recognition unit 156 may recognize whether the person who has exited the vehicle is wearing a quarantine suit.

The vehicle-exiting-person information recognition unit 156 may determine whether the detected person is a person exiting the vehicle on the basis of at least one of whether tracking information of the detected person is present, whether there is an overlapping vehicle, and a movement speed, and when it is determined that the detected person is the person exiting the vehicle, the vehicle-exiting-person information recognition unit 156 may crop a person image on the basis of the coordinates of the person exiting the vehicle, apply deep learning to the cropped person image to determine whether the person exiting the vehicle is wearing a quarantine suit, and recognize the information on the person exiting the vehicle.

That is, the vehicle-exiting-person information recognition unit 156 may determine whether there is tracking information of the detected person, and when it is determined that there is no tracking information, the vehicle-exiting-person information recognition unit 156 may determine that the detected person is a new person. In this case, the vehicle-exiting-person information recognition unit 156 may check whether there is a person detected in a previous frame to determine whether there is tracking information of the detected person. When there is no tracking information of the detected person, the vehicle-exiting-person information recognition unit 156 may generate new tracking and determine whether the detected person is a person detected outside a screen. When it is determined that the detected person is the person detected outside the screen, the vehicle-exiting-person information recognition unit 156 may search for whether there is a vehicle (overlapping vehicle) that overlaps the detected person at the person's tracking start location, and when there is an overlapping vehicle, the vehicle-exiting-person information recognition unit 156 may check whether an average speed of movement of persons in the frame is lower than a preset reference value (reference speed). Here, the reason for determining whether the person is detected outside the screen and whether there is an overlapping vehicle is to prevent misrecognition due to the case where the vehicle region overlaps with a nearby worker rather than the person exiting the vehicle. When the detected person within a preset number of frames moves slower than the preset reference value (reference speed) and overlaps with the vehicle, the vehicle-exiting-person information recognition unit 156 may recognize the detected person as the person exiting the vehicle.

When the detected person is recognized as the person exiting the vehicle, the vehicle-exiting-person information recognition unit 156 may determine whether the person exiting the vehicle is wearing a quarantine suit. In this case, the vehicle-exiting-person information recognition unit 156 may recognize whether the person exiting the vehicle is wearing the quarantine suit by applying deep learning to the person exiting the vehicle. That is, when the person exiting the vehicle is recognized, the vehicle-exiting-person information recognition unit 156 may call a function for determining whether a person is wearing a quarantine suit, retrieve the coordinates of the detected object in an object detection model using the called function, and extract the coordinates of the person who has exited the vehicle from among the vehicle, the person, and the license plate. Then, the vehicle-exiting-person information recognition unit 156 may crop the person image on the basis of the coordinates of the person extracted from the corresponding frame, input the cropped person image into a pre-trained AI model, and check whether the person is wearing a quarantine suit.

The wild animal information recognition unit 157 may recognize the wild animal information including types of wild animals detected by the object detection unit 153, whether the detected wild animal is a dead body and a recognition distance to the dead body. Here, the wild animals may include wild birds, which are vectors for avian influenza, and wild boars, which are vectors for African swine fever.

When a wild animal is detected, the wild animal information recognition unit 157 may identify a species of the detected wild animal. In this case, the wild animal information recognition unit 157 may recognize the species of the wild animal using a deep learning model. For example, the wild animal information recognition unit 157 may classify wild birds known to be vectors for avian influenza into ducks, geese, and swans in detail using a deep learning model, and check their populations.

Further, the wild animal information recognition unit 157 may measure a body temperature of the wild animal on the basis of temperature distribution information of the thermal image that matches the real image in which the wild animal is detected, and determine whether the wild animal is a dead body on the basis of the measured body temperature. That is, the wild animal information recognition unit 157 may extract the coordinates of the wild animal from the real image in which the wild animal is detected, and check the temperature distribution information corresponding to the coordinates of the wild animal in the thermal image that matches the real image. Thereafter, the wild animal information recognition unit 157 may measure the body temperature of the wild animal on the basis of the temperature distribution information of the wild animal. When the measured body temperature is less than or equal to a preset reference body temperature, the wild animal information recognition unit 157 may determine that the corresponding wild animal is a dead body.

When the detected wild animals is a dead body, the wild animal information recognition unit 157 may recognize a distance to the dead body on the basis of the distance measurement information measured through the distance measurement sensor module 126.

For example, the wild animal information recognition unit 157 may recognize wild birds, which are vectors of livestock diseases, their population, current statuses of dead bodies, etc., as shown in FIG. 4.

As described above, the object information recognition and processing unit 154 may recognize at least one of the vehicle information, the information on the person exiting the vehicle, and the wild animal information.

The metadata generation unit 158 may generate at least one of the vehicle information, the information on the person exiting the vehicle, and the wild animal information that are recognized by the object information recognition and processing unit 154, and the device status information of the apparatus 100 for monitoring vectors of livestock diseases as metadata, and transmit the generated metadata to the management server 200 through the communication module 130. That is, the metadata generation unit 158 may generate vehicle metadata information on the basis of the vehicle information, generate vehicle-exiting-person metadata information on the basis of the information on the person exiting the vehicle, and generate wild animal metadata information on the basis of the wild animal information. Further, the metadata generation unit 158 may generate device status metadata information on the basis of the device status information that allows confirmation of whether the apparatus 100 for monitoring vectors of livestock diseases is operating normally. Here, the device may be the apparatus 100 for monitoring vectors of livestock diseases, and the device status information may include power on information on whether momentary power of the apparatus 100 for monitoring vectors of livestock diseases is turned on, and alive information for determining whether the apparatus 100 for monitoring vectors of livestock diseases is operating normally.

The power on information may include an event, a device ID, a time, etc. at the moment power is applied to the apparatus 100 for monitoring vectors of livestock diseases, as shown in Table 2 below.

TABLE 2

| Key item | Value type | Description |
|---|---|---|
| “event” | String | “Power_on” |
| “device_id” | String | Device ID name |
| “time” | String | ”YearMonthDate_HourMinuteSecond” |

The alive information is information for determining whether the apparatus 100 for monitoring vectors of livestock diseases is operating normally, may be generated at a preset time period, and may include an event, a device ID, a stream status, a time, etc., as shown in Table 3 below.

TABLE 3

| Key item | Value type | Description |
|---|---|---|
| “event” | String | “alive” |
| “device_id” | String | Device ID name |
| “stream_status” | String | “ok” or “error” |
| “time” | String | “YearMonthDate_HourMinuteSecond” |

The vehicle metadata information may include an event, a device ID, a vehicle type, a vehicle license number, a vehicle image, a time, etc., as shown in Table 4 below. In this case, in preparation for license plate recognition errors or non-recognition, the vehicle image may be in the form of a screenshot (image file).

TABLE 4

| Key item | Value type | Description |
|---|---|---|
| “event” | String | “car_info” |
| “device_id” | String | Device ID name |
| “car_type” | String | @ vehicle type information |
| | | Passenger car: “for riding,” |
| | | Truck: “freight,” |
| | | Van: “riding together,” |
| | | Special car: “specific,” |
| | | Two-wheeled vehicle: “two wheels,” |
| | | and |
| | | Do not know: “unknown” |
| “plate_number” | String | Hangul/numeric characters |
| “image” | Image | Image file |
| “time” | String | ”YearMonthDate_HourMinuteSecond” |

The vehicle-exiting-person metadata information is information on a person exiting the vehicle that visits a livestock farm or a wild animal habitat, and may include an event, a device ID, the number of vehicles, the number of people, the number of people exiting the vehicle, an image of the person exiting the vehicle, a time, etc., as shown in Table 5 below. In this case, in order to check the quarantine management status of the person exiting the vehicle, the image of the person exiting the vehicle may be generated in the form of a screenshot (image file).

TABLE 5

| Key item | Value type | Description |
|---|---|---|
| “event” | String | “person_info” |
| “device_id” | String | Device ID name |
| “car_count” | Int | Number of vehicles |
| “person_count” | Int | Number of people |
| “person_step_down” | Int | Number of persons exiting vehicle |
| “image” | Image | Image file |
| “time” | String | ”YearMonthDate_HourMinuteSecond” |

The wild animal metadata information may include species of wild animals, a population, the number of dead bodies, a dead body recognition distance, an image of a wild animal, a time, etc. For example, the metadata generation unit 158 may generate metadata information on species of wild animals, a population, and the number of dead wild birds living in migratory bird habitats, which are major vectors for avian influenza. The wild bird metadata information may include an event, a device ID, a wild bird species, a wild bird population, the number of wild bird dead bodies, a wild bird dead body recognition distance, a wild bird image, a time, etc., as shown in Table 6 below. In this case, in order to check the status of the wild bird habitat, related images may be generated in the form of a screenshot (image file).

TABLE 6

| Key item | Value type | Description |
|---|---|---|
| “event” | String | “car_info” |
| “device_id” | String | CCTV ID name |
| “wildbird_type” | String | @ Wild bird information |
| | | Ducks: “duck,” |
| | | Geese: “wild goose,” |
| | | Swans: “swan,” |
| | | Others: “others,” and |
| | | Do not know: “unknown” |
| “wildbird_number” | Int | Size of wild bird population |
| “deadbody_number” | Int | Number of wild bird dead bodies |
| “distance” | Float | Wild bird dead body recognition |
| | | distance |
| “image” | Image | Image file name |
| “time” | String | ”YearMonthDate_HourMinuteSecond” |

The metadata generation unit 158 may store metadata including at least one of the vehicle metadata information, the vehicle-exiting-person metadata information, the wild animal metadata information, and the device status metadata information in a specific directory folder. Then, the metadata generation unit 158 may automatically transmit the metadata to the management server 200 by an upload folder client program.

The communication module 130 may be built into or connected to the apparatus 100 for monitoring vectors of livestock diseases through a connector, and may be linked to a communication network to provide a communication interface required to provide transmission and reception signals between the apparatus 100 for monitoring vectors of livestock diseases and the management server 200 in the form of packet data. In particular, the communication module 130 may transmit the metadata generated by the processor 150 to the management server 200. The communication module 130 may be implemented in various forms that enable communication in fields without the Internet such as a wireless communication module, such as long-term evolution (LTE) and low power wide area (LPWA), a mobile communication module, or the like.

The power module 140 may supply power to the communication module 130, the sensor module 120, and the processor 150. The power module 140 may supply power on the basis of energy harvesting. That is, the power module 140 may be implemented as a battery that converts natural energy such as sunlight, wind power, heat, etc. into electrical energy so that it can be installed in places where power is not supplied, such as wild migratory bird habitats and wild boar appearance regions. Further, the power module 140 may be implemented as a battery or the like.

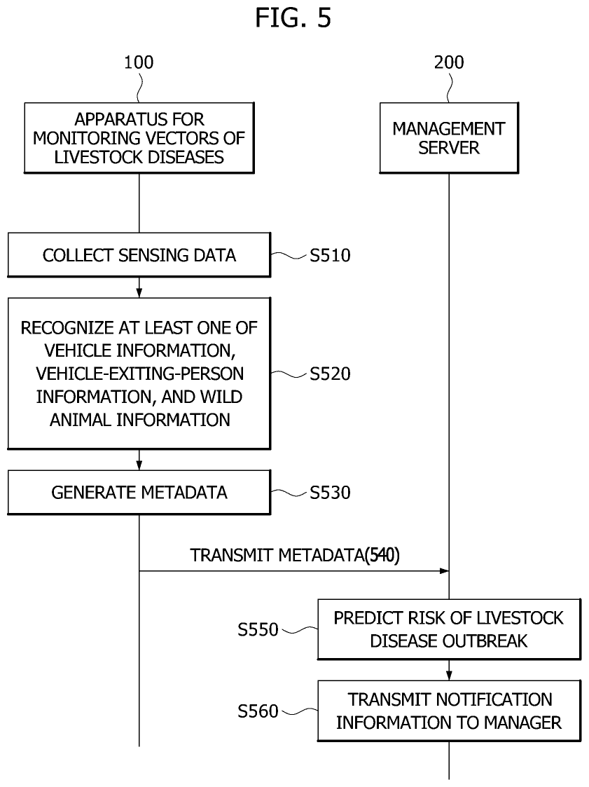

FIG. 5 is a diagram for describing a method of managing vectors of livestock diseases according to an embodiment of the present invention.

Referring to FIG. 5, an apparatus 100 for monitoring vectors of livestock diseases collects sensing data including at least one of a thermal image, a real image, and distance measurement information through a sensor module 120 (S510), and recognizes at least one of information on a vehicle entering or exiting a corresponding region, information on a person exiting a vehicle, and information on a wild animal on the basis of the collected sensing data (S520). In this case, the apparatus 100 for monitoring vectors of livestock diseases may detect at least one object among a vehicle, a person exiting a vehicle, and a wild animal on the basis of the sensing data. When a vehicle is detected, the apparatus 100 for monitoring vectors of livestock diseases may recognize vehicle information including a type and license number of the detected vehicle. When a person is detected, the apparatus 100 for monitoring vectors of livestock diseases may recognize information on the person exiting the vehicle including whether the detected person has exited the vehicle or whether he or she is wearing a quarantine suit. When a wild animal is detected, the apparatus 100 for monitoring vectors of livestock diseases may recognize wild animal information including whether the detected wild animal is a dead body and a recognition distance to the dead body.

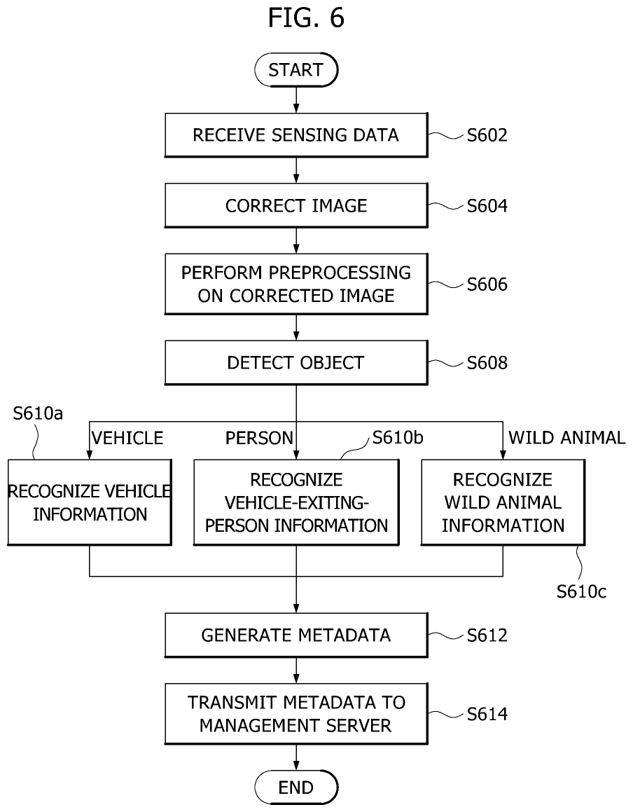

Detailed descriptions of a method for the apparatus 100 for monitoring vectors of livestock diseases to recognize at least one of vehicle information, information on a person exiting a vehicle, and wild animal information will be given with reference to FIG. 6.

When operation S520 is performed, the apparatus 100 for monitoring vectors of livestock diseases generates metadata including the recognized information and device status information (S530) and transmits the generated metadata to the management server 200 (S540). That is, the apparatus 100 for monitoring vectors of livestock diseases may generate vehicle metadata information on the basis of the vehicle information, generate vehicle-exiting-person metadata information on the basis of the information on the person exiting the vehicle, and generate wild animal metadata information on the basis of the wild animal information. Further, the apparatus 100 for monitoring vectors of livestock diseases may generate device status metadata information on the basis of the device status information that allows confirmation of whether the apparatus 100 for monitoring vectors of livestock diseases is operating normally.

When operation S540 is performed, the management server 200 predicts the degree of risk a livestock disease outbreak on the basis of the metadata received from the apparatus 100 for monitoring vectors of livestock diseases (S550) and transmits notification information including the predicted degree of risk a livestock disease outbreak to a manager (S560). In this case, the management server 200 may store the metadata received from the apparatus 100 for monitoring vectors of livestock diseases and apply the stored metadata to a prediction model to predict the degree of risk a livestock disease outbreak or the degree of risk livestock disease transmission. Thereafter, the management server 200 may transmit the notification information including the predicted degree of risk a livestock disease outbreak or degree of risk livestock disease transmission to the manager. Further, the management server 200 may generate at least one of vehicle metadata information, vehicle-exiting-person metadata information, wild animal metadata information and device status metadata information included in the metadata as notification information and transmit the generated notification information to the manager.

FIG. 6 is a flowchart for describing a method of monitoring vectors of livestock diseases according to an embodiment of the present invention.

Referring to FIG. 6, the processor 150 of the apparatus 100 for monitoring vectors of livestock diseases receives sensing data including at least one of a thermal image, a real image, and distance measurement information from the sensor module 120 (S602).

When operation S602 is performed, the processor 150 corrects the thermal image and the real image to match each other (S604). In this case, the processor 150 may adjust intrinsic parameters of the first image sensor module 122 that acquires the thermal image and the second image sensor module 124 that acquires the real image, and correct the thermal image and the real image to match each other. An object location of the thermal image and an object location of the real image may be matched through image matching.

When operation S604 is performed, the processor 150 performs preprocessing on the corrected real image (S606). In this case, the processor 150 may perform at least one preprocessing process such as adjusting the number of frames per second, converting a size of the frame, and data augmentation on the corrected real image.

When operation S606 is performed, the processor 150 detects an object corresponding to a preset class in the preprocessed real image (S608). In this case, the processor 150 may apply an object detection algorithm to the preprocessed real image to detect a vehicle, a person, a wild animal, etc.

When a vehicle is detected as a result of operation S608, the processor 150 recognizes vehicle information including a type and license number of the detected vehicle (S610a). In this case, the processor 150 may recognize the vehicle type by inputting a vehicle image into a deep learning model. Here, the vehicle type may include a passenger car, a truck, a van, a special car, etc. Further, the processor 150 may recognize the vehicle license number by applying deep learning to the license plate of the detected vehicle.

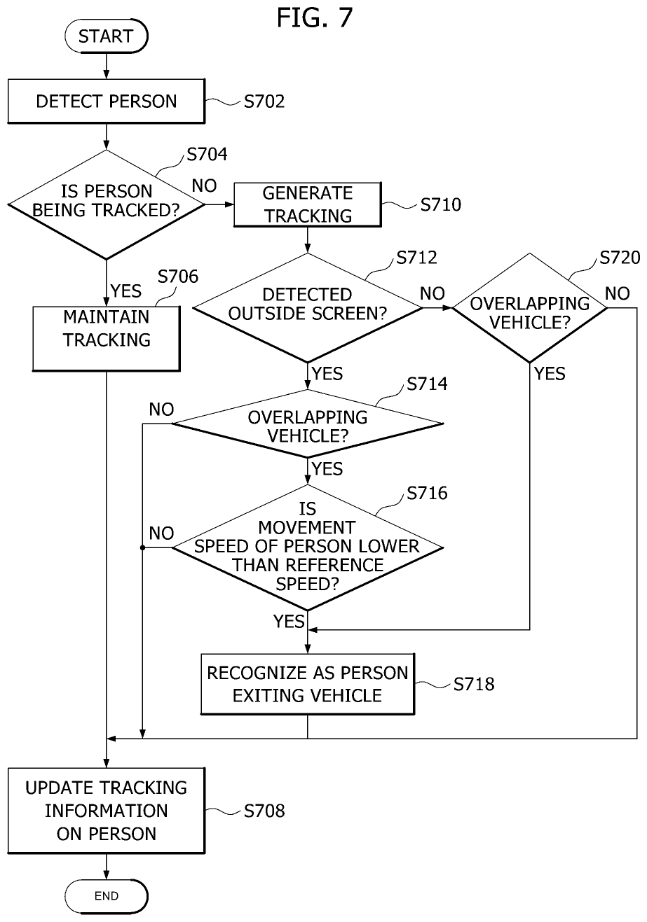

When a person is detected as a result of operation S608, the processor 150 recognizes information on the person exiting the vehicle including whether the detected person is a person who has exited the vehicle (S610b). In this case, the processor 150 may determine whether the detected person is a person who has exited the vehicle on the basis of at least one of whether tracking information of the detected person is present, whether there is an overlapping vehicle, and a movement speed, and when it is determined that the detected person is the person who has exited the vehicle, the processor 150 may crop a person image on the basis of the coordinates of the person exiting the vehicle, apply deep learning to the cropped person image to determine whether the person exiting the vehicle is wearing a quarantine suit, and recognize the information on the person exiting the vehicle. Detailed description of the method for the processor 150 to determine whether the detected person is the person exiting the vehicle the vehicle will be given with reference to FIG. 7.

When a wild animal is detected as a result of operation S608, the processor 150 recognizes wild animal information including a type of the detected wild animal, whether the detected wild animal is a dead body and a recognition distance to the dead body (S610c). In this case, the processor 150 may recognize the species of the wild animal using a deep learning model. Further, the processor 150 may measure a body temperature of the wild animal on the basis of temperature distribution information of the thermal image that matches the real image in which the wild animal is detected, and determine whether the wild animal is a dead body on the basis of the measured body temperature. When the detected wild animal is a dead body, the processor 150 may recognize a distance to the dead body through distance information measured through the distance measurement sensor module 126.

Operations S610a, S610b, and S610c may be simultaneously performed.

When operation S610 is performed, the processor 150 may generate at least one of vehicle information, information on the person exiting the vehicle, and wild animal information that are recognized, and device status information of the apparatus 100 for monitoring vectors of livestock diseases as metadata (S612), and transmit the generated metadata to the management server 200 (S614).

As described above, the processor 150 of the apparatus 100 for monitoring vectors of livestock diseases may transmit distribution status of wild animals in the corresponding wild animal habitat, a current status of a population, current statuses of dead bodies, information on vehicles visiting habitats, information on the person exiting the vehicle, or the like to the management server 200.

FIG. 7 is a flowchart for describing a method of recognizing a person exiting a vehicle according to an embodiment of the present invention.

Referring to FIG. 7, when a person is detected (S702), the processor 150 determines whether there is tracking information on the detected person (S704). In this case, the processor 150 may check whether there is a person detected in the previous frame to determine whether there is tracking information on the detected person.

When it is found in operation S704 that there is tracking information on the detected person, the processor 150 maintains the existing tracking (S706) and updates the tracking information on the detected person (S708). That is, when there is the existing tracking information, the processor 150 may determine that the detected person is not a new person and maintain the tracking of the corresponding person.

When it is found in operation S704 that there is no tracking information on the detected person, the processor 150 generates new tracking (S710) and determines whether the detected person is a person detected outside a screen (S712). That is, when there is no existing tracking information, the processor 150 may determine that the person is a new person and generate tracking for the new person. In this case, the processor 150 may generate tracking by providing identification information or the like to the detected new person.

When it is found in operation S712 that the person is the person detected outside the screen, the processor 150 determines whether there is a vehicle (overlapping vehicle) that overlaps the detected person at the person's tracking start location (S714). Here, the reason for determining whether a person is detected outside the screen and whether there is an overlapping vehicle is to prevent misrecognition due to the case where the vehicle region overlaps with a nearby worker rather than the person exiting the vehicle.

When it is found in operation S714 that there is an overlapping vehicle at the person's tracking start location, the processor 150 determines whether a movement speed of the person in the frame is lower than a preset reference value (reference speed) (S716). In this case, the processor 150 may determine whether the detected person within a preset number of frames moves slower than the reference value (reference speed).

When it is found in operation S716 that the movement speed of the person is less than or equal to the reference value, the processor 150 recognizes the detected person as the person exiting the vehicle (S718) and performs operation S708.

When it is found in operation S716 that the movement speed of the person is greater than the reference value, the processor 150 performs operation S708.

When it is found in operation S714 that there is no overlapping vehicle at the person's tracking start location, the processor 150 performs operation S708.

When it is found in operation S712 that the person is not the person detected outside the screen, the processor 150 determines whether there is a vehicle (overlapping vehicle) that overlaps the detected person (S720).

When it is found in operation S718 that there is a vehicle that overlaps the detected person, the processor 150 performs operation S718.

When it is found in operation S720 that there is no vehicle that overlaps the detected person, the processor 150 performs operation S708.

As described above, according to an aspect of the present invention, the present invention has the effect of installing an apparatus for monitoring vectors of livestock diseases, which includes a communication module and a sensor module, in a region without electricity and the Internet to enable remote monitoring of vectors of livestock diseases in the corresponding region.

According to another aspect of the present invention, the present invention has the effect of a management server managing information on entering or exiting vehicles, information on a person exiting a vehicle, and wild animal information that are recognized through an apparatus for monitoring vectors of livestock diseases, and enable monitoring of distribution status of wild animals in wild animal habitats of each region, current statuses of dead bodies, and information on quarantine of vehicles/persons visiting the habitats, and thus predict the degree of risk a livestock disease outbreak or the degree of risk livestock disease transmission and allow action to be taken.

According to an aspect of the present invention, the present invention has the effect of installing an apparatus for monitoring vectors of livestock diseases, which includes a communication module and a sensor module, in a region without electricity and the Internet to enable remote monitoring of vectors of livestock diseases in the corresponding region.

According to another aspect of the present invention, the present invention has the effect of a management server managing information on entering or exiting vehicles, information on a person exiting a vehicle, and wild animal information that are recognized through an apparatus for monitoring vectors of livestock diseases, and enable monitoring of distribution status of wild animals in wild animal habitats of each region, current statuses of dead bodies, and information on quarantine of vehicles/persons visiting the habitats, and thus predict the degree of risk a livestock disease outbreak or the degree of risk livestock disease transmission and allow action to be taken.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. An apparatus for monitoring vectors of livestock diseases, comprising:
a communication module;
at least one sensor module; and
a processor configured to recognize at least one of information on a vehicle entering or exiting a corresponding region, information on a person exiting a vehicle, and information on a wild animal on the basis of sensing data collected through the at least one sensor module and transmit the recognized information and device status information to an external device through the communication module.

2. The apparatus of claim 1, wherein the sensor module includes:
a first image sensor module configured to acquire a thermal image;
a second image sensor module configured to acquire a real image; and
a distance measurement sensor module configured to measure a distance to an object.

3. The apparatus of claim 1, wherein the processor includes:
an image correction unit configured to correct the thermal image acquired through the first image sensor module and the real image acquired through the second image sensor module to match each other;
an object detection unit configured to detect at least one object among a vehicle, a person, and a wild animal corresponding to a preset class in the corrected real image;
an object information recognition and processing unit configured to, when a vehicle is detected by the object detection unit, recognize vehicle information including a type and license number of the detected vehicle, when a person is detected by the object detection unit, recognize information on the person exiting the vehicle, including whether the detected person is exiting the vehicle or whether he or she is wearing a quarantine suit, and when a wild animal is detected by the object detection unit, recognize wild animal information including whether the detected wild animal is a dead body and a recognition distance to the dead body; and
a metadata generation unit configured to generate at least one of the information on the vehicle, the information on the person exiting the vehicle, and the information on the wild animal that are recognized by the object information recognition and processing unit, and device status information of the apparatus for monitoring vectors of livestock diseases as metadata.

4. The apparatus of claim 3, wherein the processor further includes a preprocessing unit configured to perform at least one operation among adjusting a number of frames per second, converting a size of the frame, and data augmentation on the real image corrected by the image correction unit.

5. The apparatus of claim 3, wherein the image correction unit adjusts intrinsic parameters of the first image sensor module and the second image sensor module to perform image matching in which locations of objects match in the thermal image and the real image.

6. The apparatus of claim 3, wherein the object information recognition and processing unit determines whether the detected person is a person exiting the vehicle on the basis of at least one of whether there is tracking information on the detected person, whether there is an overlapping vehicle, and a movement speed, and when the detected person is the person exiting the vehicle, the object information recognition and processing unit crops a person image on the basis of coordinates of the person exiting the vehicle, applies deep learning to the cropped person image to determine whether the person exiting the vehicle is wearing a quarantine suit, and recognizes the information on the person exiting the vehicle.

7. The apparatus of claim 3, wherein the object information recognition and processing unit measures a body temperature of the wild animal on the basis of temperature distribution information of the thermal image that matches the real image in which the wild animal is detected, determines whether the wild animal is a dead body on the basis of the measured body temperature, and when it is determined that the wild animal is a dead body, recognizes a distance to the dead body measured through the distance measurement sensor module.

8. The apparatus of claim 3, wherein the device status information includes power on information on whether momentary power of the apparatus for monitoring vectors of livestock diseases is turned on, and alive information for determining whether the apparatus for monitoring vectors of livestock diseases is operating normally.

9. A system for managing vectors of livestock diseases, comprising:
a plurality of apparatuses for monitoring vectors of livestock diseases that are each installed in a wild animal habitat and configured to recognize at least one of information on a vehicle entering or exiting a corresponding region, information on a person exiting a vehicle, and information on a wild animal and transmit metadata including the recognized information and device status information to a management server; and
the management server configured to predict at least one of a degree of risk livestock disease transmission and a degree of risk a livestock disease outbreak on the basis of the metadata received from the plurality of apparatuses for monitoring vectors of livestock diseases.

10. The system of claim 9, wherein the management server applies at least one of the information on the vehicle, the information on the person exiting the vehicle, and the information on the wild animal to an infectious disease prediction model to predict at least one of the degree of risk livestock disease transmission and the degree of risk a livestock disease outbreak.

11. The system of claim 9, wherein the management server generates notification information including at least one of the information on the vehicle, the information on the person exiting the vehicle, and the information on the wild animal, the device status information, the degree of risk livestock disease transmission, and the degree of risk a livestock disease outbreak and transmits the generated notification information to a preset manager.

12. A method of monitoring vectors of livestock diseases, comprising:
receiving, by a processor, sensing data including at least one of a thermal image, a real image, and distance measurement information from a sensor module;
recognizing, by the processor, at least one of information on a vehicle entering or exiting a corresponding region, information on a person exiting a vehicle, and information on a wild animal on the basis of the sensing data; and
generating, by the processor, metadata including the recognized information and device status information and transmitting the generated metadata to a management server.

13. The method of claim 12, wherein the recognizing of the information includes:
correcting, by the processor, the thermal image and the real image to match each other;
detecting, by the processor, at least one object among a vehicle, a person, and a wild animal corresponding to a preset class in the corrected real image; and
when a vehicle is detected, recognizing, by the processor, vehicle information including a type and license number of the detected vehicle, when a person is detected, recognizing information on the person exiting the vehicle, including whether the detected person is exiting the vehicle or whether he or she is wearing a quarantine suit, and when a wild animal is detected by an object detection unit, recognizing wild animal information including whether the detected wild animal is a dead body and a recognition distance to the dead body.

14. The method of claim 13, further comprising, after the correcting of the thermal image and the real image, performing, by the processor, at least one preprocessing operation among adjusting a number of frames per second, converting a size of the frame, and data augmentation on the corrected real image.

15. The method of claim 13, wherein, in the correcting of the thermal image and the real image, the processor adjusts intrinsic parameters of a first image sensor module that acquires the real image and a second image sensor module that acquires the thermal image to perform image matching in which locations of objects match in the thermal image and the real image.

16. The method of claim 13, wherein, in the recognizing of the information, the processor determines whether the detected person is a person exiting the vehicle on the basis of at least one of whether there is tracking information on the detected person, whether there is an overlapping vehicle, and a movement speed, and when the detected person is the person exiting the vehicle, the processor crops a person image on the basis of coordinates of the person exiting the vehicle, applies deep learning to the cropped person image to determine whether the person exiting the vehicle is wearing a quarantine suit, and recognizes the information on the person exiting the vehicle.

17. The method of claim 13, wherein, in the recognizing of the information, the processor measures a body temperature of the wild animal on the basis of temperature distribution information of the thermal image that matches the real image in which the wild animal is detected, determines whether the wild animal is a dead body on the basis of the measured body temperature, and when it is determined that the wild animal is a dead body, recognizes a distance to the dead body measured through a distance measurement sensor module.

18. The method of claim 12, wherein the device status information includes power on information on whether momentary power of the apparatus for monitoring vectors of livestock diseases is turned on, and alive information for determining whether the apparatus for monitoring vectors of livestock diseases is operating normally.
